(19) United States
(12) Patent Application Publication
(10) Pub. No.: US 2014/0010613 A1
(43) Pub. Date: Jan. 9, 2014

(54) ANTIGALLING ANCHOR BOLT AND METHOD

(71) Applicant: Black & Decker Inc., Newark, DE (US)

(72) Inventors: Paul Gaudron, Stratford, CT (US); Mark Cerbone, White Plains, NY (US)

(73) Assignee: Black & Decker Inc., Newark, DE (US)

(21) Appl. No.: 14/026,390

(22) Filed: Sep. 13, 2013

Related U.S. Application Data
(63) Continuation-in-part of application No. 12/263,934, filed on Nov. 3, 2008.

(51) Int. Cl. F16B 13/06

(52) U.S. Cl. CPC F16B 13/063
USPC 411/44

(57) ABSTRACT

Disclosed is an anchor bolt including a metal wedge having a surface with a plurality of anti-galling protrusions and a metal sleeve in operable communication with the surface. The sleeve is expandably receptive to the surface. The plurality of anti-galling protrusions is configured and disposed to produce a substantially smooth loading curve for the anchor bolt.

### CROSS-REFERENCE TO RELATED APPLICATION

This application is a Continuation-In-Part of U.S. application Ser. No. 12/263,934 filed Nov. 3, 2008, the disclosure of which is incorporated by reference herein in its entirety.

### BACKGROUND

Galling is a condition that can occur when two pieces of the same, or similar metals are rubbed together. Galling can be a problem if the two surfaces are intended to move relative to each other in use. Friction between the surfaces results in localized material transfer between the surfaces. Generally galling occurs when the two surfaces experience relative motion while subject to a sufficient compressive stress to permit the transfer of material. The stress between the surfaces tends to disrupt any protective oxide layer that is naturally present and allow metal-to-metal contact. Pure metal-to-metal contact without an oxide or other separating layer will facilitate a cold welding process thereby joining the surfaces together and preventing further relative motion therebetween.

Galling often occurs between a wedge portion and an expansion sleeve portion of an anchor bolt when installing the anchor bolt into a base material. Depending upon the severity of the galling, the expander sleeve may be pulled from the base material rather than expanded properly by the expander portion of the bolt, thereby defeating the anchor. Additionally, galling increases the force required for removal of the anchor during intended disassembly.

In previous designs, attempts have been made to alleviate galling through the use of smooth surfaces on the wedge portion and smooth surfaces on the expansion sleeve portion and/or the use of lubricants at the interface between the wedge portion and the expansion sleeve portion. However, even when a lubricant is used, galling can still occur, resulting in a non-smooth loading curve. In addition, the use of lubricants can limit the applications for use of the anchor bolt, such as in areas of high temperature or food production. Finally, lubricants can have a negative effect on the load capacity of an anchor bolt (e.g., early pull through failure of the wedge portion sliding completely through the expansion sleeve portion under a lower load).

### SUMMARY OF THE INVENTION

According to one aspect of the invention, an anchor bolt includes a metal wedge having a surface with a plurality of anti-galling protrusions and a metal sleeve in operable communication with the surface. The metal sleeve is expandably receptive to the surface. The plurality of anti-galling protrusions is configured and disposed to produce a substantially smooth loading curve for the anchor bolt.

According to another aspect of the exemplary embodiment, an anchor bolt includes a metal wedge having a surface with a plurality of anti-galling protrusions, and a metal sleeve in operable communication with the surface. The metal sleeve is expandably receptive to the surface. At least one of the surface and the sleeve is devoid of lubricant.

### BRIEF DESCRIPTION OF THE FIGURES

The following descriptions should not be considered limiting in any way. With reference to the accompanying drawings, like elements are numbered alike:

FIG. 1 depicts a side view of an anchor bolt having a wedge provided with protrusions in the form of a diamond knurled wedge, according to an aspect of the exemplary embodiment;

FIG. 2 depicts a cross sectional side view of the anchor bolt of FIG. 1 at arrows 2-2;

FIG. 3 depicts a side view of an anchor bolt having a wedge provided with protrusions in the form of cross knurlings, according to another aspect of the exemplary embodiment;

FIG. 4 depicts a side view of an anchor bolt having a wedge provided with protrusions in the form of longitudinal ridges, according to yet another aspect of the exemplary embodiment;

FIG. 5 depicts a side view of an anchor bolt having a wedge provided with protrusions in the form of latitudinal ridges, according to still another aspect of the exemplary embodiment; and

FIG. 6 is a graph of a substantially smooth loading curve facilitated by the protrusions, in accordance with the exemplary embodiment compared with a graph that illustrates galling effects during loading of a conventional fastener.

### DETAILED DESCRIPTION

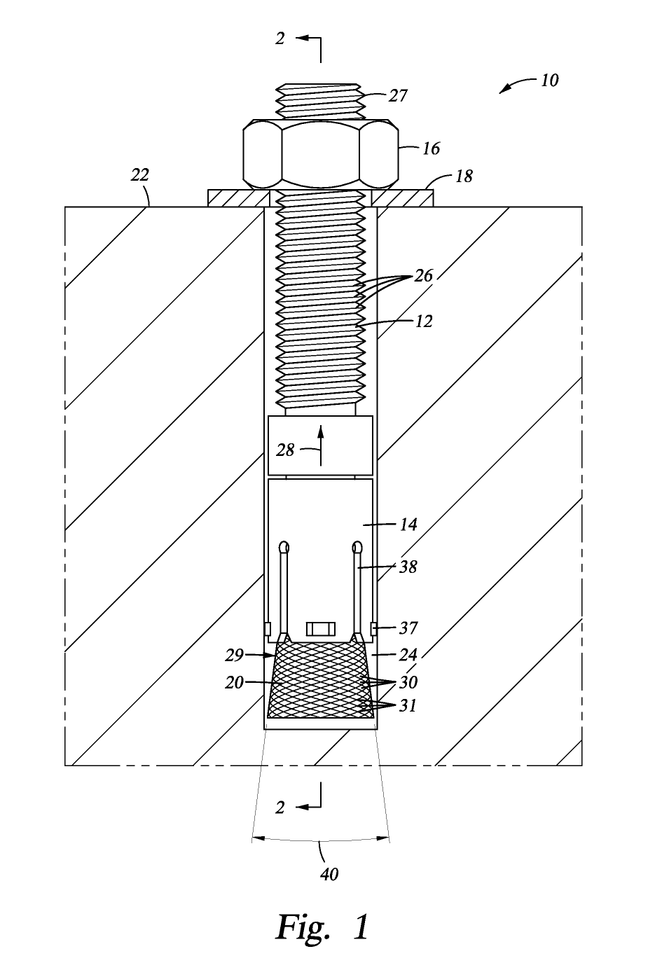

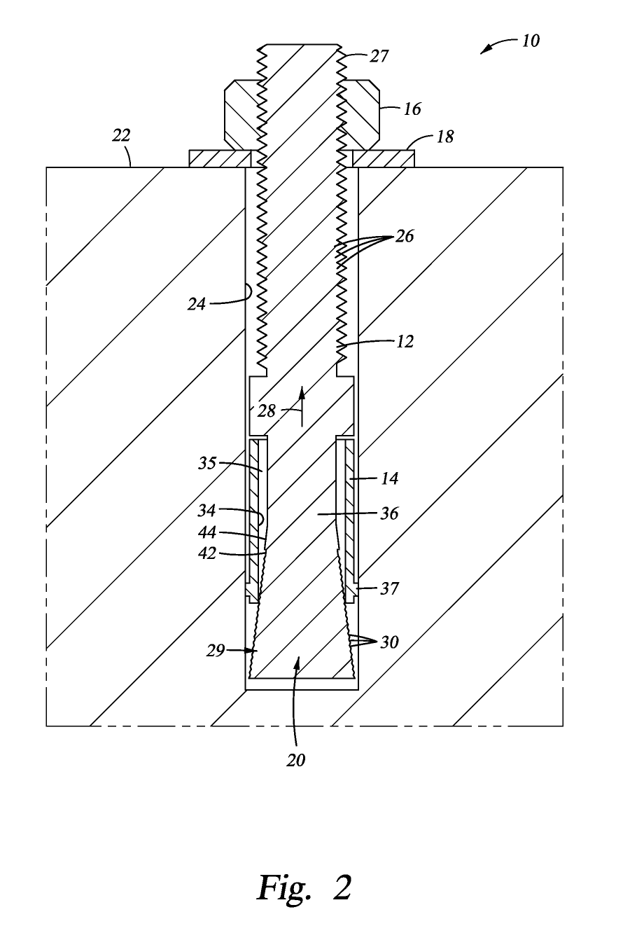

Referring to FIGS. 1-5, an embodiment of an anchor bolt 10 disclosed herein is shown. The anchor bolt 10 includes a stud 12, a sleeve 14, a nut 16 and an optional washer 18. The stud has a wedge 20 that is configured to radially expand the sleeve 14 during setting of the anchor bolt 10 into a base material 22. To set the anchor bolt 10, the anchor bolt 10 is first inserted into a hole 24 made in the base material 22, the hole 24 having a diameter only slightly larger than that of the wedge 20. The nut 16 engages threads 26 on a portion 27 of the stud 12 that protrudes from the base material 22. Turning the nut 16 pulls the stud 12 and the wedge 20 in a setting direction, as shown by arrow 28, while the sleeve 14 remains stationary in the base material 22 due to friction therebetween. As the wedge 20 moves in the direction of arrow 28, the sleeve 14 is expanded radially outwardly. Since the diameter of the hole 24 does not change appreciably due to the expansion input, the anchor bolt 10 becomes substantially anchored in the base material 22. In embodiments disclosed herein, an outer tapered surface 29 of the wedge 20 includes a plurality of anti-galling protrusions 30. The anti-galling protrusions 30 on the surface 29 reduce galling between the surface 29 and the sleeve 14 during setting and/or in service. Additionally, in the event that some galling does occur, the existence of the anti-galling protrusions 30 reduces a force needed to break the galled components apart and thus allows anti-galling protrusions 30 to move without deleterious effects to anchor performance. In an implementation, the interface between the surface 29 and the sleeve 14 is substantially devoid of any lubricant. In addition, anti-galling protrusions 30 form a plurality of interstitial air pockets (not separately labeled). Air trapped in the air pockets may lead to rapid oxidation of surface 29 in and around anti-galling protrusions 30 that will reduce galling.

The surface 29 of the wedge 20 has a generally tapered shape that may be conical for wedges 20 having a round cross section. Further, an angle 40 of the taper of the surface 29 may remain constant over a longitudinal length of the surface 29 as illustrated herein. Alternately, the angle 40 may be variable over the longitudinal length. Embodiments herein are not limited to being conical in shape, however, and may be any other shape that is effective in acting as a wedge. In addition, a recess 42 is arranged between wedge 20 and stud 12. Recess 42 is a remnant of knurling wedge 20. More specifically, wedge 20 is initially formed having a reduced diameter. Once, knurled, surface 29 grows to a final dimension and recess 42 is formed. In this manner, a smoother transition exists between surface 29 and an upper, unknurled portion 44 of wedge 20.

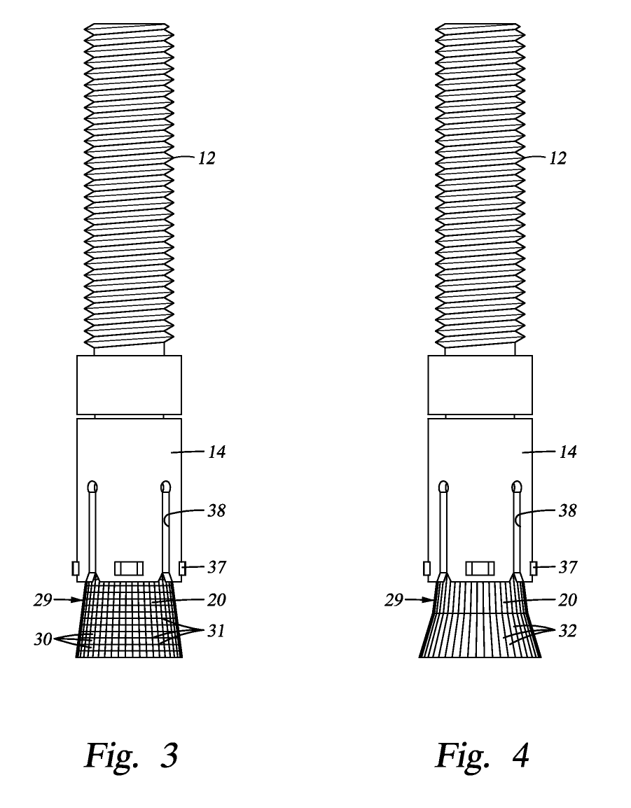

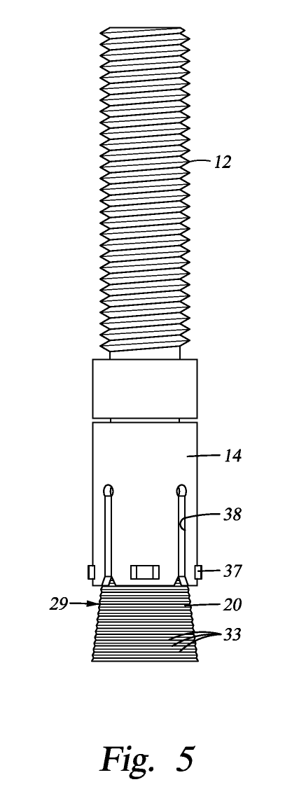

The surface 29 as shown includes a plurality of recessions or valleys 31 that exist between adjacent ones of the plurality of anti-galling protrusions 30. In an implementation, the recessions or valleys 31 between adjacent ones of the plurality of anti-galling protrusions 30 is substantially devoid of lubricants. The plurality of anti-galling protrusions 30 may have a knurled pattern. In the example depicted in FIG. 1, the anti-galling protrusions 30 have a diamond pattern. In other embodiments, the anti-galling protrusions 30 may have a cross knurled pattern, as shown in FIG. 3, for example. Additionally, the anti-galling protrusions 30 may be in the form of a series of longitudinal ridges 32, as shown in FIG. 4, or a series of latitudinal ridges 33, as shown in FIG. 5. Alternately, the anti-galling protrusions 30 may not have any particular pattern. It should be understood that the anti-galling protrusions 30 reduce the contact surface area between the surface 29 and the sleeve 14 during setting and may take any form that achieves this purpose.

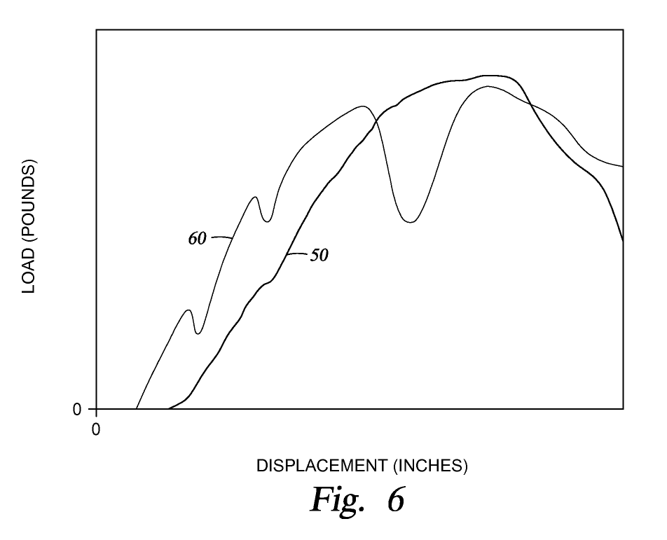

In accordance with an aspect of the exemplary embodiment, plurality of anti-galling protrusions 30 take the form of a 21-teeth per inch (TPI) diamond knurl that is devoid of a lubricant on an anchor bolt 10 having a ½ inch diameter. The 21-TPI diamond knurl has been shown to advantageously reduce uncontrolled slippage and produce a substantially smooth loading curve 50, such as shown in FIG. 6, when anchor bolt 10 is exposed to an axial force. More specifically, when exposed to an axial force urging anchor bolt 10 from a substrate, anti-galling protrusions 30 reduce galling resulting in substantially smooth loading curve 50. In contrast, prior art anchor bolts, when exposed to an axial force, generally experience galling. The galling causes surface portions of the wedge to interlock, or grab, with surface portions of the sleeve creating a curve, such as shown at 60 in FIG. 6. Curve 60 is shown to include one or more interruptions caused by a release and subsequent interlock of the surface portions. The 21-TPI diamond knurl also advantageously reduces surface contact area between surface 29 and an inner surface of sleeve 14. The reduced surface contact area decreases galling. The use of anti-galling protrusions 30 to decrease galling is counter-intuitive; previously it was believed that a smooth surface would result in a decrease of a likelihood of galling by reducing the amount of force per unit area resulting from a larger contact surface. Further, it should be understood that other knurling patterns including 25 TPI knurl patterns, 30 TPI knurl patterns, and 90 degree diamond knurl patterns may also be used.

In addition to reducing surface contact area, the process of applying the diamond knurl changes material properties of wedge 20. More specifically, applying anti-galling protrusions 30 changes hardness properties of wedge 20. The change in hardness properties further reduces galling due to a hardness differential between wedge 20 and sleeve 14. In addition, it has been found that the shape of the anti-galling protrusions 30 facilitates a plastic deformation or smearing along surface 29. The smearing of surface 29 still further reduces galling. More specifically, valleys 31 provide room for material to flow without interlocking and causing a galling effect. The material flow leads to substantially smooth loading curve 50 shown in FIG. 6. Additionally, the anti-galling protrusions 30 allow for similar geometries to resist galling in a number of different alloys such as, for example, 303 stainless steel (SS), 304 SS and 316 SS.

As detailed above, the wedge 20 is in operable communication with the sleeve 14 during setting and/or service of the anchor bolt 10. In the embodiment shown in the Figures, the sleeve 14 is a fully bored formed cylindrical sleeve having an inner diameter 34 that is greater than an outer diameter 35 of a shank 36 of the anchor bolt 10. In this embodiment, the sleeve 14 is free to rotate around the shank 36 before setting. The sleeve 14 is also shown having at least one gripping projection 37. The at least one gripping projection 37 helps to grip the base material 22 and increase friction between the sleeve 14 and the hole 24 during setting of the anchor bolt 10. The at least one gripping projection 37 is shown oriented in a latitudinal direction but may also be a longitudinal projection or may have a non-axial shape. Additionally, sleeve 14 is shown having at least one longitudinal slot 38 on the body of the sleeve 14. The at least one longitudinal slot 38 allows the sleeve 14 to be radially deflected without the necessity of stretching the material of the sleeve 14 itself. In other embodiments, the sleeve 14 may be configured for being stretched.

It should be understood that the invention is not limited to the configurations depicted in the Figures. The anchor bolt may be any anchor having a metallic wedge that expands a metallic portion of the anchor during setting. Furthermore, the stud and the sleeve may be fabricated of any metal susceptible to galling, such as, stainless steel, low carbon steel, cast iron, copper, aluminum, magnesium, and titanium, for example. It should also be understood that the substantially smooth loading curve, described as being produced by the 21-TPI diamond knurl, may also be produced by the other anti-galling protrusions described above. Further it should be understood that the smooth loading provided by the anti-galling protrusions formed in the surface of the wedge enable the anchor bolt to be meet various requirements for approved use in cracked concrete installations. Further, the lack of lubricant enables the anchor bolt to satisfy requirements for use in more applications such as high temperature and food production installations.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment or embodiments disclosed as the best mode contemplated for carrying out this invention, but that the invention will include all embodiments falling within the scope of the claims.

What is claimed is:

1. An anchor bolt comprising:
a metal wedge having a surface with a plurality of anti-galling protrusions; and
a metal sleeve in operable communication with the surface, the sleeve being expandably receptive to the surface, the plurality of anti-galling protrusions being configured and disposed to produce a substantially smooth loading curve for the anchor bolt.

2. The anchor bolt of claim 1, wherein the surface has a generally tapered shape.

3. The anchor bolt of claim 2, wherein the tapered shape is conical.

4. The anchor bolt of claim 1, wherein the surface has a constant angle of taper.

5. The anchor bolt of claim 1, wherein the surface has a varying angle of taper.

6. The anchor bolt of claim 1, wherein the metal sleeve perimetrically surrounds at least a portion of the wedge.

7. The anchor bolt of claim 1, wherein the plurality of anti-galling protrusions have a corresponding plurality of recessions.

8. The anchor bolt of claim 1, wherein the plurality of anti-galling protrusions comprises a knurl formed in the surface.

9. The anchor bolt of claim 1, wherein the plurality of anti-galling protrusions includes at least one of longitudinal and latitudinal ridges.

10. The anchor bolt of claim 1, wherein the plurality of anti-galling protrusions includes a diamond knurl pattern.

11. The anchor bolt of claim 10, wherein the diamond knurl pattern comprises a 21-teeth per inch (TPI) 90-degree diamond knurl.

12. The anchor bolt of claim 1, wherein the plurality of anti-galling protrusions include a cross knurl pattern.

13. The anchor bolt of claim 1, wherein the plurality of anti-galling protrusions define a reduced contact area between the surface and the sleeve.

14. The anchor bolt of claim 1, wherein each of the surface and the sleeve is devoid of lubricant.

15. The anchor bolt of claim 1, further comprising a threaded bolt portion.

16. An anchor bolt comprising:
a metal wedge having a surface with a plurality of anti-galling protrusions; and
a metal sleeve in operable communication with the surface, the sleeve being expandably receptive to the surface, wherein an interface between the surface and the sleeve is substantially devoid of lubricant.

17. The anchor bolt of claim 16, wherein the plurality of anti-galling protrusions includes a diamond knurl pattern.

18. The anchor bolt of claim 17, wherein the diamond knurl pattern comprises a 21-teeth per inch (TPI) 90-degree diamond knurl.

19. The anchor bolt of claim 16, wherein the plurality of anti-galling protrusions define a reduced contact area between the surface and the sleeve.

20. The anchor bolt of claim 16, wherein the plurality of anti-galling protrusions have a corresponding plurality of recessions, the plurality of recessions being devoid of lubricant.
